(19) United States
(12) Patent Application Publication
(10) Pub. No.: US 2005/0114306 A1
(43) Pub. Date: May 26, 2005

(54) Integrated searching of multiple search sources

(75) Inventors: Chen Shu, Oakville, CT (US); Michael Van Der Meulen, Woodbridge, CT (US); Timothy Winkler, Ansonia, CT (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/718,108

(22) Filed: Nov. 20, 2003

(51) Int. Cl. G06F 17/30

(52) U.S. Cl. 707/3

(57) ABSTRACT

A Web Services Parallel Query (WSPQ) web service that allows a user to enter a question, parses that, distributes the question, user preferences and information parsed from the question to a number of search services. These search services then perform a search based upon the question and/or the parsed information. The search services then return results to the WSPQ web service. The WSPQ normalizes rankings of results provided by the search services, adjusts these rankings based upon default weighs or client specified weights for search service providing the result and then presents the user with a unified list of results that are sorted or prioritized based upon their rank.

### FIELD OF THE INVENTION

This invention pertains to computerized data searches and more particularly to searching for data from multiple data sources.

### BACKGROUND OF THE INVENTION

The proliferation of inter-computer communications, including intra-enterprise interconnections of computers and world wide data communications networks such as the Internet, has increased the need to develop efficient and easy to use methods to search for information from disparate data sources.

One known solution used to search for information from disparate data sources is to use meta-search engines. Meta-search engines, such as Dogpile or go2net's MetaCrawler, do not maintain databases themselves. Meta-search engines typically accept keywords for a data query from a user and then simultaneously submit those keywords to several individual search engines that maintain and search through their own databases of web pages. Meta-search engines typically wait for a set amount of time to receive results from those individual search engines and then return those results to the user.

Meta-search engines are typically constrained by the limitations of the individual search engines to which they submit data queries. Meta-search engines themselves do not support intelligent processing of natural language questions from a user seeking data. Meta-search engines also do not allow users to specify a weighting to be applied to results produced by different search engines. Meta-search engines are often tied to specific search engines and data sources and do not support easy and/or flexible addition of other existing, proprietary knowledge bases into the field of data sources to which data queries are submitted. These constraints impede the expansion of meta-search engines into a consolidated data searching resource that provides enhanced productivity for users.

Another present solution used to search for information is an advanced web search engine, such as Google, Fast, Inktomi and AskJeeves. These search engines are similar to meta-search engines in that they are able to access multiple data sources. Advanced search engines are limited, however, since they are required to constantly maintain and index locally stored repositories of information that mirror data contained in the multiple sources from which these advanced web search engines obtain information.

Therefore a need exists to overcome such problems with the present search systems as discussed above.

### SUMMARY OF THE INVENTION

According to an aspect of the present invention, a method of searching for data includes accepting a question from a client and sending the question to a plurality of search services. The method further includes receiving a plurality of results from the search services. Each of the results has an associated rank that is assigned by the search service from which that result is received. The method also includes adjusting the associated rank of at least one result based upon a weight for the search service that assigned the associated rank. The weight is assigned by at least one of a client specification and a default weighting specification.

According to another aspect of the present invention, a system of searching for data includes a parser for accepting a question from a client and a dispatcher for sending the question to a plurality of search services. The system further includes a receiver for receiving a plurality of results from the search services. Each of the results has an associated rank that is assigned by the search service from which that result is received. The system also has a normalizer for adjusting the associated rank of at least one result based upon a weight for the search service that assigned the associated rank. The weight is assigned by at least one of a client specification and a default weighting specification.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 illustrates a component interconnect diagram for the components of a parallel query system according to an exemplary embodiment of the present invention

FIG. 2 illustrates a computer system that is used to perform the processing functions for the components of the parallel query system illustrated in FIG. 1 in accordance with one embodiment of the present invention.

FIG. 3 illustrates a source weight table contents diagram according to an exemplary embodiment of the present invention.

FIG. 4 illustrates a query specification data content diagram according to an exemplary embodiment of the present invention.

FIG. 5 illustrates a search response data content diagram according to an exemplary embodiment of the present invention.

FIG. 6 illustrates a questions handling processing flow diagram according to an exemplary embodiment of the present invention.

FIG. 7 illustrates a processing flow diagram for rank adjustment processing in accordance with the exemplary embodiment of the present invention.

FIG. 8 illustrates a processing flow diagram for a natural language question parsing in accordance with the exemplary embodiment of the present invention.

### DETAILED DESCRIPTION OF PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to a preferred embodiment, overcomes problems with the prior art by providing a Web Services Parallel Query (WSPQ) web service that allows a user to enter a natural language question, parses that natural language question, distributes the natural language question, user preferences and information parsed from the question to a number of search services. These search services then perform a search based upon the question and return results to the WSPQ web service. The WSPQ normalizes rankings of results provided by the search services, adjusts these rankings based upon the search service providing the results and then presents the user with a unified list of results that are prioritized based upon their rank.

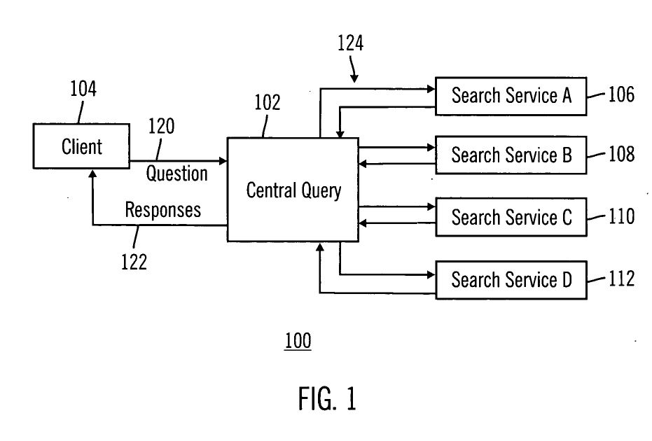

A component interconnect diagram for the components of a parallel query system 100 according to an exemplary embodiment of the present invention is illustrated in FIG. 1. The parallel query system 100 includes a central query component 102. The central query component 102 includes a Web Services Parallel Query (WSPQ) web service in the exemplary embodiment. The central query component 102 of the exemplary embodiment accepts a natural language query from one or more users. A user interacts with the parallel query system 100 through a client interface 104 suited to accept a natural language question. Client 104 is able to execute on the computer that is hosting the central query component 102 or the client 104 is able to be hosted on a different computer than is hosting the central query component 102 and is connected to the central query component 102 via a suitable communications link. Client 104 sends natural language questions 120 to the central query component 102 and receives prioritized results 122.

Central query component 102 is able to be accessed by various types of search clients 104. One type of search client that can used in the exemplary embodiment is a “Bot,” which is a programed agent that allows users to enter questions through an interface, such as an instant messaging interface, and that returns a numbered list of matching or similar questions. The list produced by the bot can be formatted, for example, into groups of 10 questions. The Bot then allows the user to select a number and see the answers to that question. Another type of search client that can be used is a “portlet.” A portlet allows users to submit questions through, for example, a form on a web page. Portlets then typically display results in an HTML format. Yet another type of search client that can be used is a stand-alone client, where the users submit their questions through that client's custom GUI, and results are returned and displayed in a specialized format, typically unique to that client.

The parallel query system 100 of the exemplary embodiment includes a Search Service A 106, Search Service B 108, Search Service C 110 and Search Service D 112. Each search service is able to be a meta-search engine, advanced search engine, custom search engine or proprietary search engine that is operated by an independent organization or by the operator of the central query component 102. In further embodiments, any number of search services can be communicatively connected to the central query component 102.

The central query component 102 is in electrical communications with the multiple search services via a digital communications network 124, such as the Internet or other suitable network. The exemplary embodiment uses the Simple Object Access Protocol (SOAP) to communicate information to the search services.

1. Exemplary Computing System

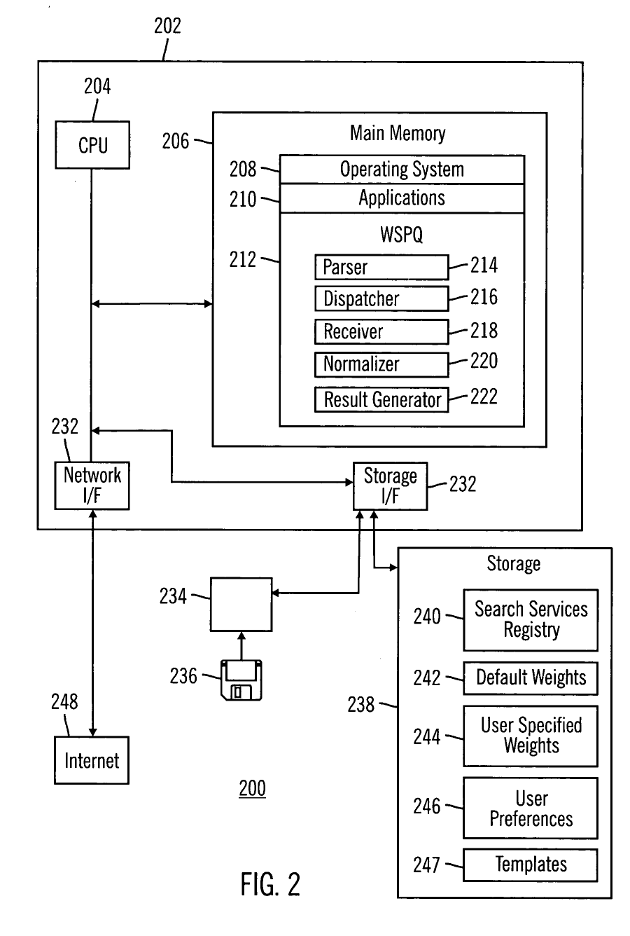

A computer system 200 that is used to perform the processing functions for the components of the parallel query system 100 according to an exemplary embodiment of the present invention is illustrated in FIG. 2. Computer system 200 includes a computer 202 that contains a Central Processing Unit (CPU) 204, a main memory 206, a network interface 230 and a storage interface 232. CPU 204 is used to execute operational programs to implement the different functions and algorithms of the exemplary embodiment of the present invention. The network interface 230 connects the computer system 200 to other computer systems via Internet 248 through a communications link. Embodiments of the present invention communicate with other computer systems via wired and/or wireless communications, dedicated digital and dial-up digital communications links and links that include terrestrial and satellite communications links.

Computer 202 has a storage interface 232 that provides an interface to storage devices to which computer 202 has access. The storage interface 232 of the exemplary embodiment includes a removable data storage adapter 234 that is able to accept removable storage media 236. The removable data storage adapter 234 is one or more of a floppy drive, magnetic tape or CD type drive. The removable storage media 236 is a corresponding floppy disk, magnetic tape or CD.

The storage interface 232 of the exemplary embodiment further connects to storage 238. In this exemplary embodiment, this storage 238 is a hard drive that stores a search services registry 240, default weights 242, user specified weights 244 configuration data such as user preferences 246, and templates 247, which are described in more detail below. Alternatively, this storage 238 can be volatile or non-volatile memory for storing some or all of this data. Additionally, in some embodiments this storage 238 is located within the computer 202 (e.g., within main memory 206 or some other internal memory or storage device). Furthermore, in some embodiments, all of the data described above is not stored in storage 238. For example, the user specified weights and user preferences are just received from the client (and temporarily stored or not stored) in some embodiments, and templates are not used at all in some embodiments.

Main memory 206 of the exemplary embodiment includes software components for operating system components 208 and applications 210. This exemplary computer system 200 includes the software component to implement the Web Services Parallel Query (WSPQ) web service 212, which is the central query component 102 of the exemplary embodiment. The WSPQ 212 includes software components to implement a parser 214, a dispatcher 216, a receiver 218, a normalizer 220 and a composite result generator 222.

The WSPQ 212 accepts a natural language question from a user through the parser 214 and parses the text of that question. The parser 214 produces a parsed representation of the natural language question. The parser 214 of the exemplary embodiment produces a list of identified and weighted terms that are derived from the natural language question. The parser assigns a weight to different parts of speech in order to better direct data searches by search services as is described below.

The WSPQ 212 contains a dispatcher 216 that prepares query specifications and send them to each of a number of search services, such as search service A 106 through search service D 112. The dispatcher 216 of the exemplary embodiment sends query specifications to search services listed in the search services registry 240. Embodiments of the present invention allow query specifications to be sent to only a subset of search services based upon, for example, identified keywords in the natural language question provided by the user 104.

The registry 240 of the exemplary embodiment stores information that describes how to communicatively find a search service provider, how to identify the search service, and what kind of information the search service is willing or capable to provide. The registry of the exemplary embodiment is able to be implemented as an XML file, a database or a Universal Description, Discovery and Integration (UDDI) registry. Search services are able to be easily added, removed or re-described in the registry 240, advantageously allowing easy reconfiguration of search services that are used to perform searches in the exemplary embodiment.

The search services of the exemplary embodiment have an Application Program Interface (API) that is an interface adapted to receive information from the WSPQ 212, including parsed representations of the natural language question and other user preferences. The search services return results that each include a rank that is associated with the result to indicate the relevance of that result to the user submitted question.

The various search services process the query specification and the WSPQ 212 waits a predetermined time to retrieve results or for the search services to return results. The receiver 218 of the WSPQ 212 retrieves or receives the results from the search services. The exemplary embodiment of the present invention incorporates a receiver 218 that stores and accumulates the results into a result pool within the receiver 218. The receiver then produces the accumulated results after the predetermined time.

The WSPQ 212 includes a normalizer 220. The normalizer of the exemplary embodiment normalizes and adjusts the rank of each identified result that is returned by the search services, as is described in more detail below. The normalizer obtains weighting factors to be applied to results from a particular search service based upon the default weights 242 and user specified weights 244, as is described below.

The result generator 222 of the exemplary embodiment sorts the identified objects according to the normalized and adjusted rank that is associated with the object and returns all or a subset of results to the user via the client 104, according to parameters specified in user preferences 246.

The exemplary embodiment of the present invention receives a list of objects from each of the search sources in response to the query specification sent to that search source. This list of objects further contains a ranking for each object in the list that indicates the strength of the relationship between the query specification and that particular object. The exemplary embodiment further allows a weighting to be applied to the rank for an object based upon the search service that is the search source that found that object. This weighting is used to accommodate an observation that one particular search source is better than another, or that the particular search source is particularly relevant to a certain query. The WSPQ of the exemplary embodiment allows multiple users to access the system and allows each of those users to store their individual preference information. Individual preference information provided by a user overrides default operating parameters generally used by the system. The exemplary embodiment of the present invention further allows each user of the system to override default rank weights so that search sources that return information of greater relevance to that user can be given a weight that is more appropriate for that user. An example of a use for user specified weights for a particular search source includes a WSPQ that primarily serves engineers but has one user responsible for financial matters. The global or default weighting for a search source focused on financial matters may be quite low since engineers are not typically interested in such data. A user focused on financial issues, however, is interested in the results of that search source, and will specify a high weighting for that source.

2. Search Service Weighting Tables

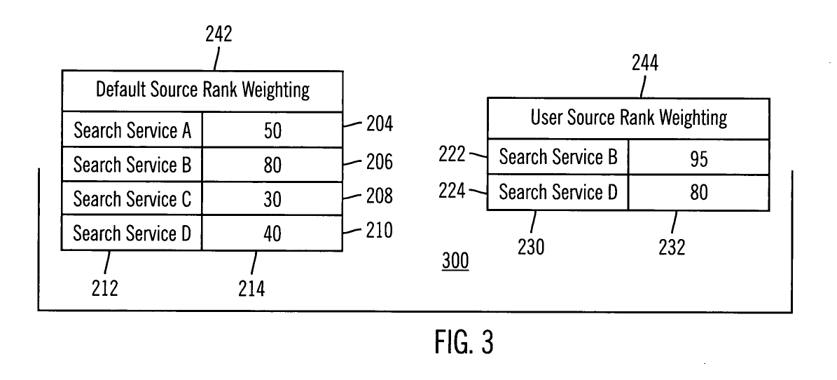

A source weight table contents diagram 300 that illustrates the contents of default weights 242 specification and user specified weights 244 specification according to an exemplary embodiment of the present invention is illustrated in FIG. 3. Default source rank weighting table 242 contains weighting factors that are to be applied to results from particular search sources in the absence of, or in addition to, a user specified rank, as is described below. The default source rank weighting table 242 shows a weighting factor for each of the search sources, search source A 106 through search source D 112.

The default source rank weighting table 242 has two columns, a search source specification column 212 and a search source weight column 214. The exemplary default source rank weighting table 242 is shown to have four entries in this example. A first default weighting entry 204 includes a search source specification of “Search Source A” and a weighting factor of “50” that is to be applied to the rank of each object identified by search source A. The remaining default weighting entries, i.e., second default weighting entry 206, third default weighting entry 208, fourth default weighting entry 210 and fifth default weighting entry 212, contain similar information. The weighting factors contained within the search source weight column 214 of the exemplary embodiment are a percentage value that is applied to the rank of each result, as is described below. For example, the weighting factor of the first default weighting entry 204 is “50,” which results in the normalized rank of objects returned by Search Source A 106 being multiplied by 0.5.

The exemplary embodiment of the present invention allows users to specify weighting factors to be applied to each data source. The exemplary embodiment stores user specified source rank weighting in the user source rank weighting table 244. User specified source rank weights replace default source rank weights stored in the default source rank weighting table 242. If a user does not provide a user specified source rank weight for a particular search source, the processing of the exemplary embodiment uses the default source rank weight for that search source that is stored in the default source rank weighting table 242. Alternatively, the user specified source rank weights can be used to supplement the default source rank weights. For example, the user specified weight for a source can be multiplied by the default weight to create a composite weight. This allows the user, through client 104, the middleware, such as the WSPQ 212, and the search services to all influence the final ranking presented to the user.

The user source rank weighting table 244 of the exemplary embodiment has a structure that is similar to the default source rank weighting table 242. The user source rank weighting table 244 has two columns, a search source specification column 230 and a search source weight column 232. The exemplary user source rank weighting table 244 is shown to have two entries in this example. A first user weighting entry 222 includes a search source specification of “Search Source B” and a weighting factor of “95” that is to be applied to the rank of each object identified by search source A. The second user weighting entries contains similar information. The weighting factors contained within the search source weight column 230 of the exemplary embodiment are also a percentage value as in the default source rank weighting table 242.

3. Message Structures

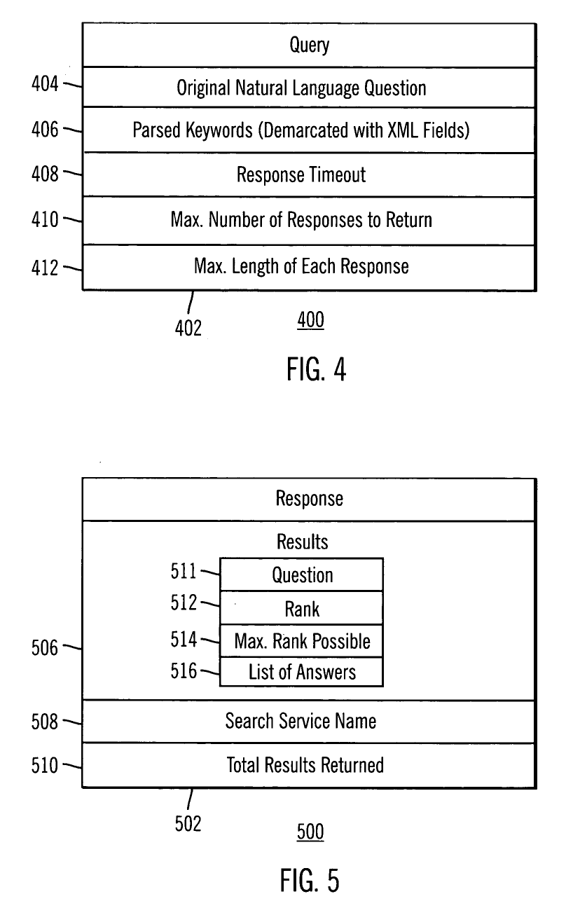

A query specification data content diagram 400 according to an exemplary embodiment of the present invention is illustrated in FIG. 4. A query specification 402 is produced by the dispatcher 216 of the exemplary embodiment based upon parsed information produced by the parser 214. The query specification 402 of the exemplary embodiment is an XML formatted data object that is provided to each search service using parallel SOAP calls. The query specification 402 of the exemplary embodiment contains the natural language question as submitted by the user. The original natural language question 404 is provided in the query specification 402 that is sent to each search service so that the search service is able to apply its own processing to assist in formulating a search and ranking results.

The query 402 of the exemplary embodiment further contains a list of parsed keywords 406. The list of parsed keywords in the exemplary embodiment contains grammatical information that describes the natural language question 404. The list of parsed keywords is contained within XML tags that indicate the weight to be given to each parsed keyword. For example, an XML tag that identifies a list of words as nouns indicates that those words are to be given a high weight.

The query 402 of the exemplary embodiment includes a specification of a response timeout 408. The response timeout conveys the predetermined time for which the WSPQ of the exemplary embodiment will wait for search services to return results and then process the results that were accumulated during that specified response timeout period. The search services use this response timeout value to limit the time that the search service spends in searching, so as to advantageously limit the resources expended by that search service in performing the search.

Query specification 204 further contains a specification of a maximum number of results to return 410. The maximum number of results to return 410 is used by the search service to limit the number of objects whose descriptions are returned to the central query component 102. This allows the search service to potentially reduce processing resources used for the query and reduces the number of results that the central query component 102 has to handle. The query specification 402 further includes a maximum length of each result 412, which specifies a number of bytes that the search service is to supply to describe each object found that was responsive to the search.

A search response data content diagram 500 according to an exemplary embodiment of the present invention is illustrated in FIG. 5. A search response 502 is returned by each search service in response to a query specification 402. The search response 502 of the exemplary embodiment contains a results data structure 506 that contains, for each result, a question 511, a rank indicator 512, a maximum rank possible value 514 and a list of answers 516. The question field 511 in this embodiment contains a question that is the result returned by the search service. More specifically, it is a question from the responding search service's database that matches the user's natural language query.

The rank indicator 512 indicates the rank of the result, which is a search service determination of how well the found object relates to the user's natural language query. The rank value produced by a search service is determined by each search service using known techniques. The maximum rank possible value 514 indicates the highest rank value that can be assigned by that search service, and is used by the WSPQ 212 to normalize the rank value 512. The list of answers 516 contains one or more answers from the search service's database for the question 511. This information is included for each result returned by the search service. In further embodiments, each result (i.e., search response data) is not in the form of a question 511 and list of answers to that question 516. For example, in one embodiment each search result is an answer from the responding search service's database that matches the user's natural language query.

The search response 502 of the exemplary embodiment also contains the search service name 508 that is used by the WSPQ 212 to identify the search service that produced the search response 502. The search response 502 further contains a value indicating the total number of results returned 510 that indicates the total number of results returned by that search service for this question.

4. Processing Flow Descriptions

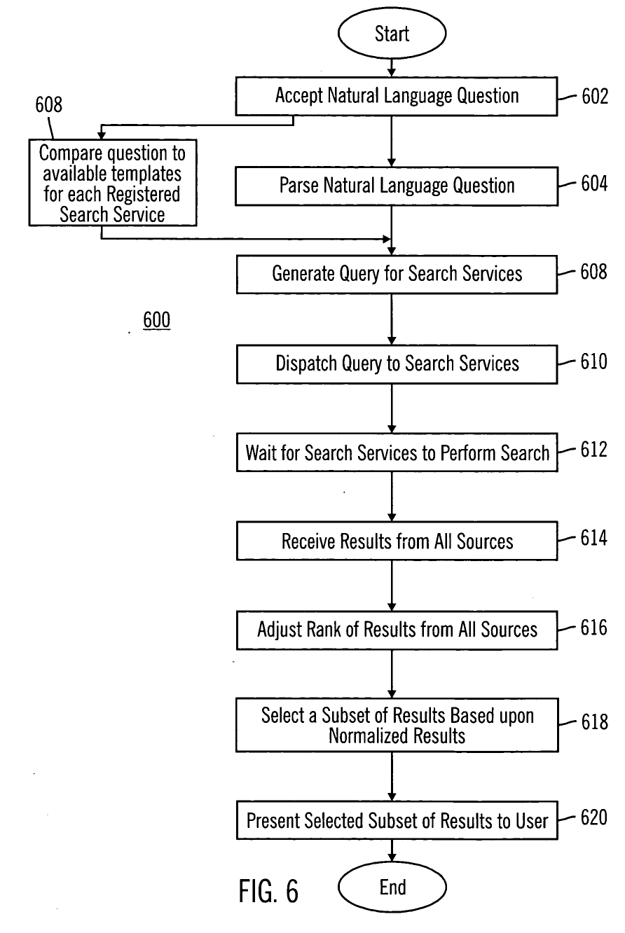

A questions handling processing flow diagram 600 according to an exemplary embodiment of the present invention is illustrated in FIG. 6. The handling processing flow begins by accepting, at step 602, a natural language query from a client 104. As noted above, this natural language query is able to be provided by a user at a workstation that is remote from the computing system performing the question handling functions or the same workstation performing the question handling functions.

Once the natural language query is accepted, the processing continues by parsing, at step 604, the natural language question that was provided by the user, as is described in more detail below. Alternatively, the system can accept a boolean query, another format of query, a command, or a statement from the client.

At optional step 606, the query is compared to available query templates for each registered search service. In the exemplary embodiment, the query templates are used to apply word and/or pattern matching to the original query text to determine whether or not the query should be sent to a corresponding search service, as described in more detail in the example below. This optional feature advantageously allows a specialized search service that is part of the system to only receive relevant queries, as described in more detail below.

The processing continues by generating a query specification 402 for each search service listed in the search service registry 240 that had a matching template (or all search services if templates are not used). Once the query specification is generated, the processing dispatches, at step 610, the query specification to the search services using parallel SOAP calls and waits, at step 612, for a predetermined time. The predetermined time that the processing waits is configurable and is chosen to balance search completeness and thoroughness with speed.

After the predetermined time has expired, the processing then retrieves or receives, at step 614, a set of results from the search services. The processing of the exemplary embodiment buffers the search results from the search services into a result pool and receives the results from this memory pool after the predetermined time has expired.

After receipt of the results from all sources, the processing continues by adjusting, at step 616, the rank of the results. The exemplary embodiment uses the value in the “maximum rank possible” field 514 of the result to first normalize the rank of each result to a scale with a maximum rank of one hundred (100). This advantageously allows results from different sources that use a different maximum ranking scale to be directly compared and sorted by rank. Once the rank of each result is normalized to a common scale, the processing adjusts the rank according to the user specified source weights and/or default source weights, and then sorts the results, as is described below.

Once the rank of the results from all sources have been normalized and the weighting has been applied, the processing of the exemplary embodiment continues with an optional step of selecting, at step 618, a subset of results based upon normalized results. The subset consists of a specified number of results that have the highest rank of the returned results. The number of results in this subset is determined by a default or user specified number (e.g., that is entered along with the natural language question or that is stored in the user preferences 246). The default or user specified parameter for the number of results is able to also indicate that all results are to be selected as the subset.

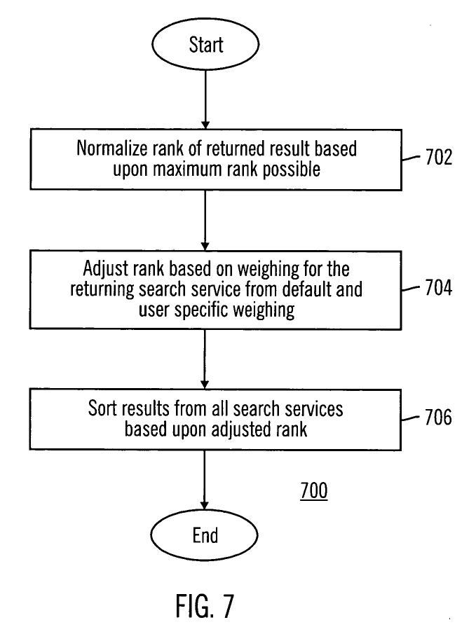

After a subset of results are selected, the processing continues by presenting, at step 620, the selected subset of results to the user. The subset is communicated to the client and is displayed according to default and/or user specified preferences. A processing flow diagram for rank adjustment processing 616 as is performed by the exemplary embodiment of the present invention is illustrated in FIG. 7. The rank normalization processing begins by normalizing, at step 702, the rank of each returned result based upon the maximum rank possible as specified in the “maximum rank possible” field 514. The exemplary embodiment normalizes the ranks to a common scale with a maximum value of 100.

The rank adjustment processing then continues by adjusting, at step 704, the rank of results based upon weighting for the search service that returned that result. The weighting values are obtained in the exemplary embodiment from the default source rank weighting table 242 and the user source rank weighting table 244 by using one or the other, or a combination of both weights, as is described above. After the normalization and adjustment of the rank of each result, the processing of the exemplary embodiment sorts, at step 706, the results according to the normalized and adjusted rank of each result. The rank adjustment processing is then finished for this set of results.

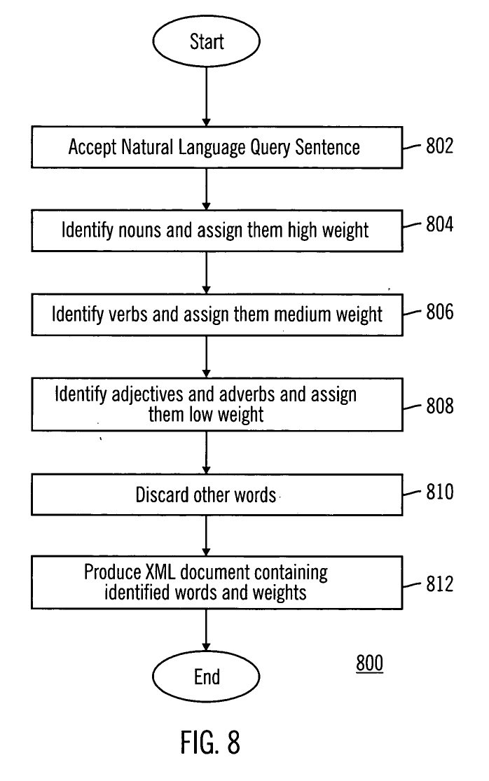

A natural language question parsing processing flow diagram 800 according to an exemplary embodiment of the present invention is illustrated in FIG. 8. Natural language question parsing is used in the exemplary embodiment to determine grammatical information about the natural language question submitted by a user in order to better specify a data search query to find information that is most relevant to that natural language question. The natural language question parsing beings by accepting, at step 802, a natural language query sentence from a client 104. The processing then identifies, at step 804, the nouns in the natural language question sentence. Nouns are assigned a high weight since they are likely to contain the most important specification of information that the user desires. The processing then identifies, at step 806, verbs that are in the natural language question sentence. Verbs are assigned a medium weight since they are likely to contain some indication of the information that the user desires, but are likely to be less definitive than nouns. The processing next identifies, at step 808, adjectives and adverbs in the natural language question sentence. Adjectives and adverbs are then assigned a low weight since they are likely to contain some indication of the information that the user desires, but are likely to be less definitive than nouns and verbs. The processing continues by discarding, at step 810, other words in the natural language question sentence, such as prepositions and identifiers.

The natural language question parsing 800 of the exemplary embodiment continues by producing, at step 812, an XML compliant document containing the grammatical information determined by the above processing. This XML document has XML tags that delimit the identified words, the identified parts of speech of each of the words and the weight assigned to each identified word.

5. Operating Example

A detailed example of the operation of the exemplary embodiment in an illustrative transaction is as follows. The WSPQ 212 in this example has 6 registered Search Services available with default weights as follows:
Technical (100)
Financial (70)
Big Search (90)
w3forums (80)
General FAQ Search (65)
StockQuoter (100)

In this example, the particular user overrides the weights to be given to 2 Search Services in his preferences:
Financial (100)
Technical (90)

In this example, the user then submits the following natural language question.
“Where can I get the Annual Report for 2003?”

The parser 214 of the WSPQ 212 receives this question and parses the sentence. The dispatcher 216 returns an XML document containing the parsed sentence back to the WSPQ program 212. Additionally, in this embodiment the WSPQ uses query templates provided by each Search Service to determine which search services should be sent the query. More specifically, word and/or pattern matching is performed using the query templates and the original question text to determine whether or not the query should be sent to a corresponding search service. In this example, the “StockQuoter” search service only answers questions relating to stock ticker prices, so it's only query template reads “*stock*”. Here, the word “stock” is not found anywhere in the original question so there is no match with this template. The “Big Search” search service is a general purpose that answers any question, so it's query template reads “*”. The question matches ths wildcard template and also matches one or more templates for each of other four search services, so the dispatcher 216 send the data out to 5 of the 6 Search Services in parallel.

The query sent to the 5 Search Services in parallel contains the following information:
question in original text format
parsed keywords (XML identifying parts of speech)
timeout (30 sec)
maximum number of answer to be returned (10)
maximum length in characters of each answer (256)

The search services perform searches in parallel as follows.

Financial:

Chooses to use the parsed XML keywords
According to it's own algorithm, weights the words ‘where’ and ‘annual’ as keywords, ‘report’ as a noun with double weight, and ‘2003’ also as doubly important.
Search it's database and returns the 10 best question/answer pairs as results:
   Where is the 2003 Annual Report (100%)
   Where do I find Financial Report Statement March, 10th 2003 (85%)
   Where is the Annual Report 2002 (80%)
   Etc. (lower ranks)
Returns these results and other data to the WSPQ as follows.
   The results (each including a question, corresponding list of answers, rank and max rank)
   Search Service name
   Total results returned
      Technical:
Same flow, with 3 results, ranked 1-3:
   Is the 2003 Annual Report available online? (1)
   How do extract images from the Annual Report? (2)
   Where can I find reporting software for making annual reports? (3)
      The other three Services follow a similar process.

The WSPQ 212 waits until the timeout period is up. The WSPQ 212 then collects all the results from all the services (who have responded within the user's timeout period). At this point there are as many as 50 results (based on maxRank from each service).

The normalizer 220 normalizes the rank of each result on a 0-100 scale:
Where is the 2003 Annual Report (100%)
Where do I find Financial Report Statement March, 10th 2003 (85%)
Where is the Annual Report 2002 (80%)
Is the 2003 Annual Report available online? (100%)
How do extract images from the Annual Report? (67%)
Where can I find reporting software for making annual reports? (33%)
Etc.

The normalizer 220 then applies user defined (or default) weights to these ranks (100% for Financial, 90% for Technical, etc):
Where is the 2003 Annual Report (Financial, 100%)
Where do I find Financial Report Statement March, 10th 2003 (Financial, 85%)
Where is the Annual Report 2002 (Financial, 80%)
Is the 2003 Annual Report available online? (Technical, 90%)
How do extract images from the Annual Report? (Technical, 60%)
Where can I find reporting software for making annual reports? (Technical, 30%)
Etc.

The results are then sorted:
Where is the 2003 Annual Report (Financial, 100%)
Is the 2003 Annual Report available online? (Technical, 90%)
Where do I find Financial Report Statement March, 10th 2003 (Financial, 85%)
Where is the Annual Report 2002 (Financial, 80%)
How do extract images from the Annual Report? (Technical, 60%)
Where can I find reporting software for making annual reports? (Technical, 30%)
Etc.

The processing then returns the top 10 (user-specified) results from this list to the client for display to the user as a unified list of results.

6. Non-Limiting Software and Hardware Examples

Embodiments of the invention can be implemented as a program product for use with a computer system such as, for example, the computing system shown in FIG. 2 and described herein. The program(s) of the program product defines functions of the embodiments (including the methods described herein) and can be contained on a variety of signal-bearing medium. Illustrative signal-bearing medium include, but are not limited to: (i) information permanently stored on non-writable storage media (e.g., read-only memory devices within a computer such as CD-ROM disk readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method of searching for data, the method comprising the steps of:
accepting a question from a client;
sending the question to a plurality of search services;
receiving a plurality of results from one or more of the search services, wherein each of the results has an associated rank that is assigned by the search service from which the result is received; and
adjusting the associated rank of at least one result based upon a weight for the search service that assigned the associated rank, wherein the weight is assigned by at least one of a client specification and a default weighting specification.

2. The method of claim 1, further comprising the step of sending at least one user preference to the plurality of search services.

3. The method of claim 1, further comprising the step of receiving a maximum rank possible from the search services, wherein the associated rank is relative to the maximum rank possible.

4. The method of claim 1, further comprising the step of sending a subset of the results to the client, the subset being selected in dependence upon the associated ranks of the results after the adjusting step.

5. The method of claim 1, wherein the receiving step comprises storing the results in a result pool, and the method further comprises the step of retrieving the results from the result pool after a predetermined time.

6. The method of claim 1, wherein the weight assigned by the client specification overrides the weight assigned by the default weighting specification.

7. The method of claim 1, further comprising the step of receiving the question via at least one of the search services through an Application Program Interface.

8. The method of claim 1, wherein the question is a natural language question.

9. The method of claim 8, further comprising the step of sending a parsed representation of the natural language question to the search services.

10. The method of claim 9, wherein the step of sending a parsed representation includes the sub-steps of:
generating grammatical information describing the natural language question; and
providing the grammatical information to at least one of the search services.

11. A system of searching for data, the system comprising:
a parser for accepting a question from a client;
a dispatcher for sending the question to a plurality of search services;
a receiver for receiving a plurality of results from one or more of the search services, wherein each of the results has an associated rank that is assigned by the search service from which the result is received; and
a normalizer for adjusting the associated rank of at least one result based upon a weight for the search service that assigned the associated rank, wherein the weight is assigned by at least one of a client specification and a default weighting specification.

12. The system of claim 11, further comprising a result generator for sending a subset of the results to the client, the subset being selected in dependence upon the associated ranks of the results after the adjusting by the normalizer.

13. The system of claim 11, wherein the receiver further comprises a result pool for storing the results, and the normalizer further retrieves the results from the result pool after a predetermined time.

14. The system of claim 11, wherein the weight is assigned by the client specification overrides the weight assigned by the default weighting specification.

15. The system of claim 11, wherein question is a natural language question.

16. The system of claim 15,
wherein the parser further generates grammatical information describing the natural language question, and
the dispatcher provides the grammatical information to at least one of the search services.

17. A computer readable medium including computer instructions for searching for data, the computer instructions comprising instructions for:
accepting a question from a client;
sending the question to a plurality of search services;
receiving a plurality of results from one or more of the search services, wherein each of the results has an associated rank that is assigned by the search service from which the result is received; and
adjusting the associated rank of at least one result based upon a weight for the search service that assigned the associated rank, wherein the weight is assigned by at least one of a client specification and a default weighting specification.

18. The computer readable medium of claim 17, further comprising instructions for sending a subset of the results to the client, the subset being selected in dependence upon the associated ranks of the results after the adjusting.

19. The computer readable medium of claim 17, wherein the instructions for receiving comprises instructions for storing the results in a result pool and the computer readable medium further comprises instructions for retrieving the results from the result pool after a predetermined time.

20. The computer readable medium of claim 17, wherein the weight assigned by the client specification overrides the weight assigned by the default weighting specification.

21. The computer readable medium of claim 17, further comprising instructions for sending a parsed representation of the question to the search services.

22. The computer readable medium of claim 21, wherein the instructions for sending a parsed representation include instructions for:
generating grammatical information describing the natural language question; and
providing the grammatical information to at least one of the search services.
